(19) United States
(12) Patent Application Publication
(10) Pub. No.: US 2013/0275203 A1
(43) Pub. Date: Oct. 17, 2013

(54) WEB-BASED SYSTEM AND METHOD FOR SELLING A REPLACEMENT SUPPLY ITEM BASED ON THE SALES CHANNEL OF THE ORIGINAL ITEM

(71) Applicants: John Douglas Anderson, Lexington, KY (US); Timothy William Learn, Lexington, KY (US); Julie Katherine Lyons, Nicholasville, KY (US); Matthew Thomas Martinkovic, Lexington, KY (US); Timothy Rademacher, Lexington, KY (US)

(72) Inventors: John Douglas Anderson, Lexington, KY (US); Timothy William Learn, Lexington, KY (US); Julie Katherine Lyons, Nicholasville, KY (US); Matthew Thomas Martinkovic, Lexington, KY (US); Timothy Rademacher, Lexington, KY (US)

(21) Appl. No.: 13/444,146

(22) Filed: Apr. 11, 2012

(51) Int. Cl. G06Q 30/06; G06Q 30/02

(52) U.S. Cl. 705/14.39; 705/26.1; 705/26.8

(57) ABSTRACT

A method for selling a replacement supply item according to one embodiment includes in response to a scan of an encoded uniform resource identifier provided on a supply item, identifying a product type and a source type of the scanned supply item. A web page specific to the identified product type of the scanned supply item is then displayed that facilitates ordering the replacement supply item. The displayed web page varies depending on the identified source type of the scanned supply item.

### CROSS REFERENCES TO RELATED APPLICATIONS

None.

### BACKGROUND

1. Field of the Disclosure

The present invention relates generally to web-based sales methods and more particularly to a web-based method of selling replacement supply items based on the sales channel of the original item.

2. Description of the Related Art

Many devices utilize one or more supply items that must be replaced or replenished from time to time. For example, printers and copiers deposit an imaging substance, such as ink or toner, on a substrate to form a printed image. The imaging substance is housed in the reservoir of a supply item such as a tank, bottle or cartridge that supplies the imaging substance to the device. When the imaging substance is consumed by the device, the supply item must be replaced in order to continue printing. Other items that may require replacement during the life of a printing device include, for example, a fuser that bonds toner to the print substrate during a laser print operation and an imaging unit that houses a photoconductive drum and/or a developer roll for a laser printer. Other examples of supply items that must be replaced include the battery of a cell phone, laptop or other portable electronic device, various automotive parts as well as items that must be refilled such as prescriptions.

Care must be taken to ensure that the correct replacement supply item is used, otherwise the item will not function properly. For example, where the item is a supply of imaging substance for a printing device, many alternatives may be available for purchase depending on such factors as printer type (e.g., laser or inkjet), printer model, color and page yield. These variables may make it difficult for a customer to first identify a seller of the replacement supply item and then choose the correct item from a list of available options. This complexity can create customer confusion and frustration. Further, where the wrong item is purchased and then returned, the seller incurs the cost of processing the returned item and, in some instances, shipping costs associated with returning the wrong item to the seller and sending the correct item to the customer. As a result, a convenient system for ordering replacement supply items that ensures the correct item is ordered is desired.

### SUMMARY

A method for selling a replacement supply item according to one embodiment includes in response to a scan of an encoded uniform resource identifier provided on a supply item, identifying a product type and a source type of the scanned supply item. A web page specific to the identified product type of the scanned supply item is then displayed that facilitates ordering the replacement supply item. The displayed web page varies depending on the identified source type of the scanned supply item.

A method for selling a replacement supply item according to another example embodiment includes in response to a scan of a bar code provided on a supply item and having a uniform resource identifier encoded therein, identifying a product type of the scanned supply item. A first web page is displayed that displays a confirmation of the identified product type of the scanned supply item and a link to purchase the replacement supply item. When the link to purchase the replacement supply item is selected, a source type of the scanned supply item is identified and a second web page is displayed that facilitates ordering the replacement supply item. The second displayed web page varies depending on the identified source type of the scanned supply item.

A method for selling a replacement supply item according to another example embodiment includes providing a supply item having a scannable uniform resource identifier encoded thereon. The uniform resource identifier includes a product identifier that identifies a product type of the supply item and a source identifier that identifies a sales channel through which the supply item was first sold. After the scannable uniform resource identifier is scanned, a web page associated with the uniform resource identifier and specific to the identified product type of the supply item is displayed that facilitates ordering the replacement supply item. The displayed web page varies depending on the identified source type of the scanned supply item.

### BRIEF DESCRIPTION OF THE DRAWINGS

The above-mentioned and other features and advantages of the various embodiments, and the manner of attaining them, will become more apparent and will be better understood by reference to the accompanying drawings.

FIG. 1 is a diagram of a web-based system for selling replacement supply items according to one example embodiment.

FIG. 2 is a flowchart of a method for selling replacement supply items using a web-based system according to one example embodiment.

FIG. 3 is a schematic depiction of a supply item having a two-dimensional bar code thereon according to one example embodiment.

FIG. 4 is a schematic depiction of a customer device in the form of a smart phone displaying a web page for purchasing a replacement supply item according to one example embodiment.

FIG. 5A is a flowchart of a first example of a method for selling replacement supply items in response to a selection by the customer to purchase a replacement.

FIG. 5B is a flowchart of a second example of a method for selling replacement supply items in response to a selection by the customer to purchase a replacement.

### DETAILED DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense and the scope of the present invention is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

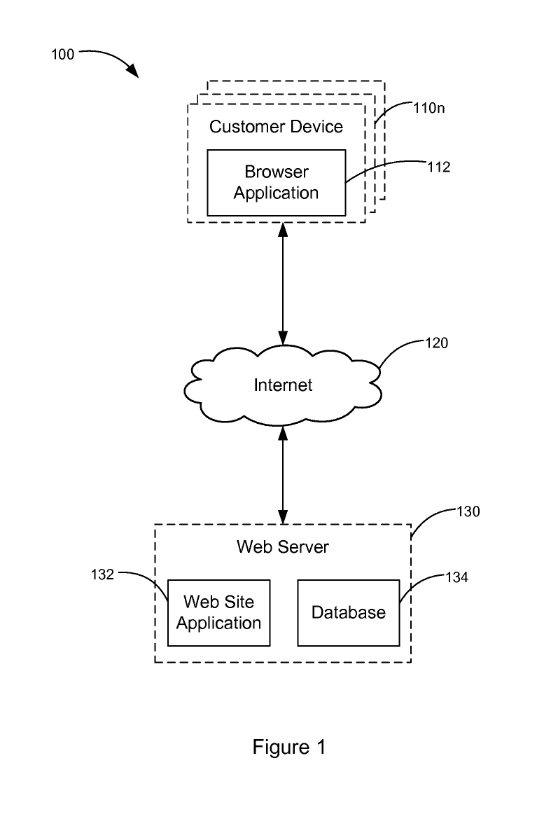

FIG. 1 shows a system 100 for selling a replacement supply item according to one example embodiment. System 100 includes various customer devices 110n, each a customer device 110, in communication with the internet 120. Each customer device 110 includes a processor and associated memory in the form of a computer-readable storage medium coupled to or otherwise in communication with the processor. The processor may include one or more general or special purpose microprocessors, or any one or more processors of any kind of digital computer. Alternatives include those wherein all or a portion of the processor is implemented by an application-specific integrated circuit (ASIC) or another dedicated hardware component as is known in the art. The processor is configured to execute computer-executable program instructions stored in the memory. The computer-readable storage media may include an electronic, optical, magnetic or other storage or transmission device capable of providing a processor with computer-readable instructions. Examples include, but are not limited to, read-only memory (ROM), random access memory (RAM), non-volatile RAM (NVRAM), optical media, magnetic media, semiconductor memory devices, flash memory devices, mass data storage devices (e.g., a hard drive, CD-ROM and/or DVD units) and/or other storage as is known in the art. Examples of customer devices 110 include personal computers, mobile or portable computers, digital assistants, cellular or mobile phones, smart phones, tablet computers, or any other processor-based device. Customer device 110 includes a web browser application 112 that facilitates communication with internet 120. Browser application 112 is a software program executing on customer device 110 that enables a user to display and interact with text, images, and other information located on a web page at a web site on internet 120 such as, for example, Internet Explorer™, Safari™, Google Chrome™, or Mozilla Firefox™. Browser application 112 may also be a stand-alone software application (or “app”), operating independently of a typical web browser, and itself capable of browsing web sites. Customer devices 110 may operate on any operating system capable of supporting browser application 112 such as Microsoft® Windows® or Linux™.

System 100 also includes a web server 130 in communication with internet 120. Similar to each customer device 110, web server 130 includes a processor in communication with computer-readable memory. Web server 130 may also be implemented as a network of computer processors. Examples include servers, mainframe computers, networked computers, or other processor-based devices or systems. Web server 130 includes a web site application 132 software program executing on web server 130. Browser application 112 may communicate with web server 130 via a standard HTTP protocol. Web site application 132 accepts web connections for operations originating from a customer device 110 and creates web pages for customer devices 110n that access a web site hosted by web server 130. Web server 130 has access to a database 134 for facilitating web-based sales transactions (or e-commerce transactions) and for storing information related to the e-commerce transactions and information related to the customers, customer devices, and/or supply items associated with the e-commerce transactions. Database 134 may be a single memory device or a network of memory devices and may be formed as a part of web server 130 or as a separate component in communication with web site application 132.

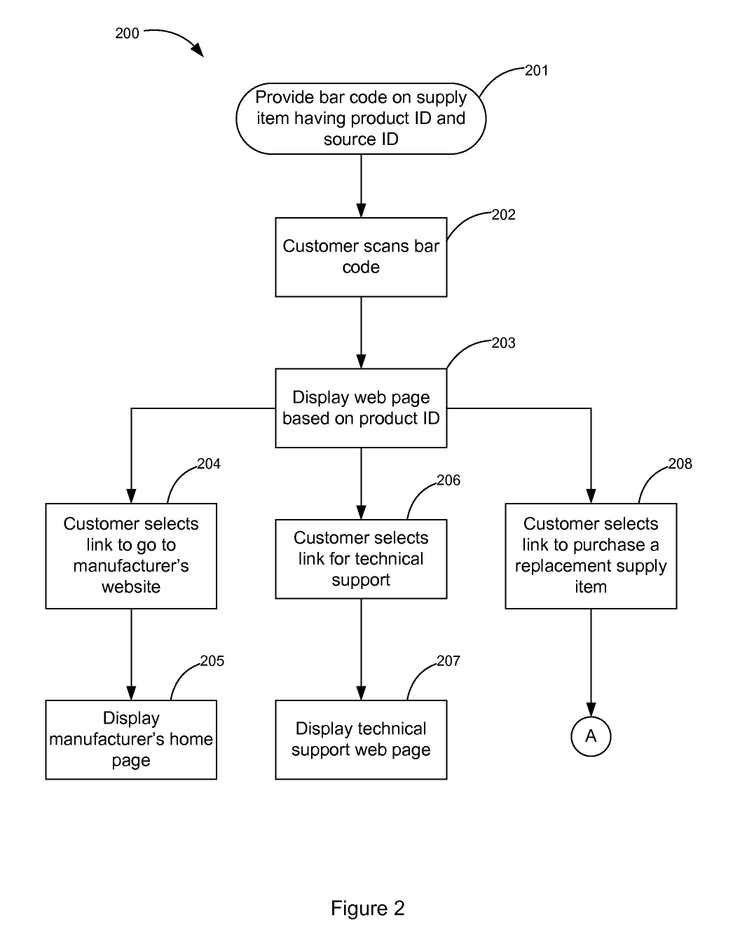

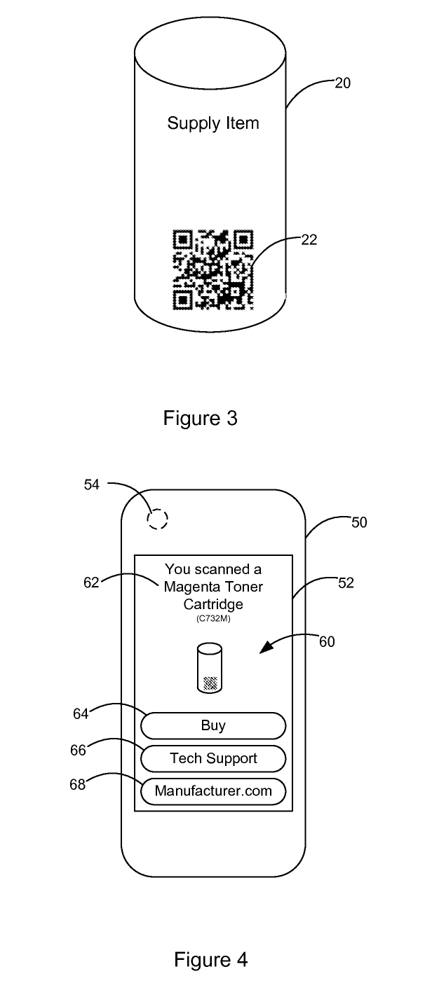

FIG. 2 shows a method 200 for selling replacement supply items using a web-based system, such as system 100. At step 201, a supply item is provided having a scannable bar code. The supply item may be of the type that is sold with or installed in a device (often referred to as a ship-with-equipment (SWE) supply item) or it may be a standalone supply item. FIG. 3 schematically depicts a supply item 20 having a scannable bar code 22. In the example embodiment illustrated, bar code 22 is a Quick Response Code™ (QR Code®). QR Codes are two-dimensional bar codes that may include binary data, numeric or alphanumeric text, or a Uniform Resource Identifier (URI) embedded therein. QR Codes were developed and patented by Nippondenso Co., Kariya, Japan but have been made publicly available for free use (see U.S. Pat. No. 5,726,435). QR Codes are defined by International Organization for Standardization (ISO) standard 18004. In other embodiments, bar code 22 may be a conventional one-dimensional bar code or a two-dimensional bar code other than a QR Code such as a High Capacity Color Barcode (HCCB) developed by Microsoft Corp., Redmond, Wash., USA. Bar code 22 may be positioned on supply item 20, such as on a label affixed to supply item 20 or printed or otherwise marked on the body of supply item 20. Alternatively, bar code 22 may be positioned on the packaging of supply item 20, for example where the size of supply item 20 makes it impossible or impractical to place bar code 22 thereon.

Bar code 22 includes a URI embedded therein to direct browser application 112 of customer device 110 to a web site hosted by web server 130 and web site application 132. The URI contains a product identifier and a source identifier. The product identifier identifies supply item 20 by type or model. The source identifier identifies the sales channel through which supply item 20 was first sold to the public, such as whether supply item 20 was sold as a SWE component or as a standalone component and/or whether supply item 20 was sold by the manufacturer direct to the customer or through an intermediate retailer. In one embodiment, the source identifier is a serial number of supply item 20. The serial number may be used to determine the source of the supply item by sorting the serial numbers for a particular supply item by their sales channels and storing this information in database 134. In this embodiment, each bar code 22 and corresponding URI is unique to its respective supply item 20. For example, if supply item 20 is a magenta toner cartridge for a “C732” model printer sold by Lexmark International, Inc., Lexington, Ky., USA, and has a serial number “123456,” the URI could be: http://www.lexmark.com/c732m?sn=123456. In this example URI, “c732” identifies the printer model, “m” identifies the cartridge's color, and “sn=123456” identifies the cartridge's serial number. It will be appreciated that any URI scheme may be used as desired depending on the web site architecture employed. Further, various portions of the URI may be altered such as by shortening the serial number using hexadecimal digits or other methods known in the art in order to fit the URI into bar code 22.

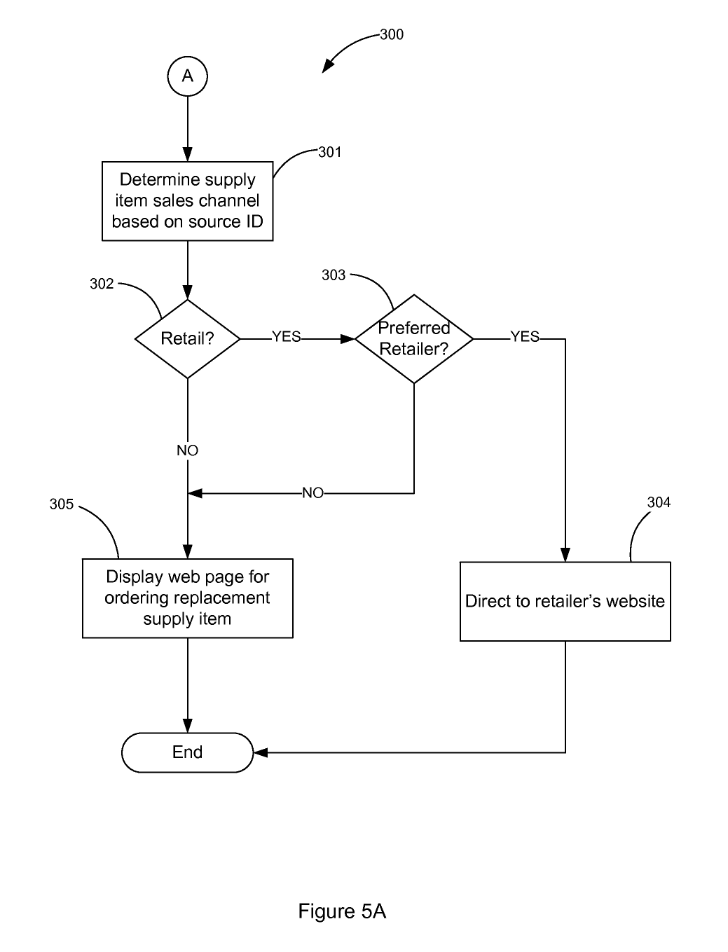

With reference back to FIG. 2, at step 202, the customer scans bar code 22, such as by using customer device 110 or a device in communication with customer device 110. For example, FIG. 4 shows an example customer device in the form of a smart phone 50. Smart phone 50 includes a display 52 and a browser application, such as browser application 112. Smart phone 50 may also include a camera 54, such as on a reverse side thereof, that may be configured to scan a QR Code or other form of bar code. As is known, software programs that enable a smart phone camera to serve as a QR Code reader are available for free download to most smart phones. When the customer scans bar code 22 using a QR Code reader, browser application 112, which may be separate from the QR Code reader software program or a part thereof, accesses web server 130 via internet 120. Alternatively, the URI may be encoded on supply item 20 in a form other than a bar code as desired. For example, near field communication (NFC) may be used instead. NFC permits a device, such as a smart phone, to establish radio communication with another device when the two devices are touched together or brought in close proximity to each other. Radio-frequency identification (RFID) may also be used as desired.

At step 203 in FIG. 2, browser application 112 displays the web page associated with the URI embedded in bar code 22. FIG. 4 shows an example web page 60 displayed on display 52. Web page 60 includes a main text and/or image portion 62 that may confirm the type of supply item scanned as determined by the product identifier portion of the URI. Web page 60 also includes various links that provide the customer with options such as a link 64 for purchasing a replacement supply item, a link 66 for requesting technical support and a link 68 for visiting the manufacturer's web site. Web page 60 is preferably displayed in the appropriate language based on the geographic location of the customer as determined, for example, by his or her IP address as is known.

At step 204, when the customer selects link 68, browser application 112 displays the manufacturer's home page at step 205. The home page displayed may vary based on the geographic location of the customer.

At step 206, when the customer selects link 66 for technical support, at step 207, browser application 112 displays the manufacturer's technical support web page, which may display the contact information for technical support or allow the customer to submit a technical support inquiry or schedule a service appointment. Where the customer device is a smart phone or other device configured to enable voice calls, the technical support web page may also facilitate a voice call with a technical support telephone number.

At step 208, when the customer selects link 64 to purchase a replacement supply item, browser application 112 is directed to a web page for purchasing the replacement supply item. Links 64, 66, 68 are meant to serve as examples and are not intended to be exhaustive of the links or options that may be presented to the customer. Further, links 66 and 68 to technical support and the manufacturer's home page may be omitted as desired.

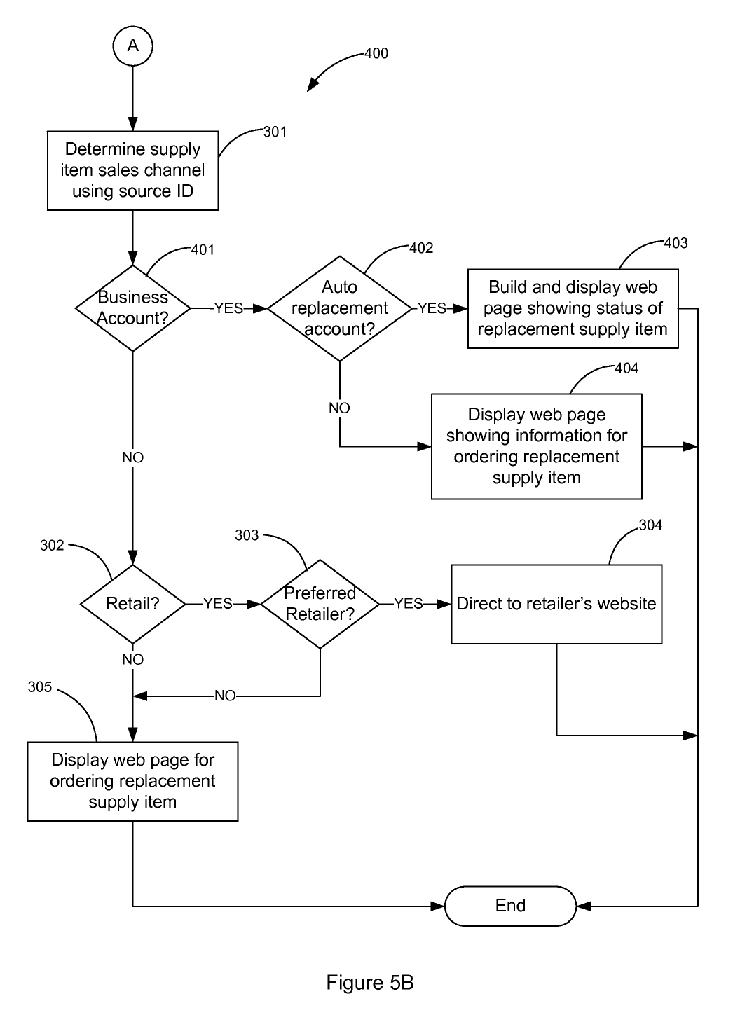

FIG. 5A illustrates a method 300 carried out by system 100 in response to the selection of link 64 to purchase a replacement supply item according to a first example embodiment. At step 301, web site application 132 determines the sales channel of the scanned supply item 20 using the source identifier in the URI embedded in bar code 22. For example, web site application 132 determines at step 302 whether the scanned supply item 20 was sold through a retail channel or sold directly by the manufacturer. Where the source identifier is the serial number of supply item 20, web site application 132 may make this determination by looking up the product information stored in database 134. Alternatively, the source identifier may itself contain an indication of the sales channel used for the scanned supply item 20.

If the scanned supply item 20 was first sold via a retail channel, the relationship between the manufacturer and the retailer may be used to determine whether browser application 112 is directed to the manufacturer's web site or to the retailer's web site. For example, at step 303, web site application 132 may determine whether the retailer associated with the scanned supply item 20 qualifies as a “preferred” retailer. This determination may be based on such factors as the relationship between the manufacturer and the retailer including whether the retailer has agreed to pay a “click through” fee for web traffic or purchases originating from the customer's scan of bar code 22 on supply item 20. If the retailer qualifies as “preferred,” browser application 112 is redirected to the retailer's web site at step 304. Alternatively, all retailers may be treated as “preferred” such that browser application 112 is always redirected to the retailer's web site if the scanned supply item 20 was first sold by a retailer.

If the retailer does not qualify as preferred or if the scanned supply item 20 was first sold directly by the manufacturer, the manufacturer's web page for ordering a replacement for the scanned supply item 20 is displayed in browser application 112 at step 305. The manufacturer's web page is an ordering page specific to the replacement supply item. Where the scanned supply item 20 is a SWE supply item, the web page for a compatible replacement item is displayed. The web page displayed at step 305 may be a “checkout page” having the replacement supply item automatically placed in the customer's online shopping cart or a page providing the customer with the ability to place the replacement item in his or her cart and proceed to checkout. Further, the customer may be granted a discount or other incentive as a reward for using bar code 22 to purchase a replacement supply item. For example, free shipping or 10% off of the replacement supply item may be offered. The incentive may vary depending on whether the scanned supply item 20 is a SWE supply item or a replacement supply item. For example, a greater discount may be applied where the scanned supply item 20 is a SWE item in order to encourage customer loyalty. Reward points may also be awarded to the customer for using the bar code to purchase a replacement supply item. For example, bar code 22 may also contain a reward code embedded therein allowing the user to claim the reward to his or her user account when bar code 22 is scanned. Placing a scannable URI on each supply item 20 provides the customer with a simple way to purchase a replacement. Including a product identifier and a source identifier in the URI ensures that the customer will find the correct replacement thereby eliminating confusion and reducing the occurrence of returns.

FIG. 5B shows a second example method 400 that may be carried out when the customer selects link 64 to purchase a replacement supply item. In this embodiment, the sales channel determination at step 301 is further divided according to whether the customer is a business account having a supply replacement procedure different from the procedure used for consumers. In some instances, manufacturers may desire to provide additional services to large business accounts as a purchasing incentive. For example, replacement supply items may be automatically delivered to the customer based on, for example, a fixed schedule or in response to an automated communication from the device requiring a replacement supply item to the manufacturer. Further, additional reordering tools may be provided to a large business account such as by providing a customer service representative or sales agent specific to the business. At step 401, web site application 132 determines whether the scanned supply item 20 was sold by the manufacturer to a customer having a qualifying business account. If it was not, method 400 proceeds to step 302 discussed above where web site application 132 determines whether the scanned supply item 20 was sold through a retail channel or directly by the manufacturer. Alternatively, if the scanned supply item 20 was not sold by the manufacturer to a customer having a qualifying business account, the method may proceed directly to step 305 discussed above where the manufacturer's web page for ordering a replacement supply item is displayed.

If the scanned supply item 20 was sold to a qualifying business account customer, at step 402, web site application 132 then determines whether the business account associated with the scanned supply item 20 uses an automatic replacement procedure. If an automatic replacement procedure is in place for the customer, browser application 112 is directed to a web page showing the status of the next replacement supply item at step 403. For example, the web page may show when the next replacement supply item will be shipped or it may show or link to the shipping status of a replacement supply item already in transit or already being processed. The web page may also include a link or form for requesting a replacement supply item. The web page may also include or link to historical information showing previous replacement supply item deliveries for the device.

If no automatic replacement procedure is in place for the customer, browser application 112 is directed to a web page containing information for ordering a replacement supply item at step 404. For example, the web page may show the contact information for a sales agent or representative responsible for the business account. The web page may also include a field that allows the customer to submit an inquiry to a sales agent or representative regarding a replacement supply item. Further, the web page may allow the customer to order the replacement supply item as discussed above with respect to step 305. For example, the web page may be an ordering page specific to the replacement supply item and may automatically place the replacement supply item in the customer's online shopping cart.

In another embodiment, bar code 22 may also be used to verify the authenticity of supply item 20. In this embodiment, in additional to the URI, bar code 22 includes an authentication code embedded therein that allows the customer to verify that supply item 20 is not a counterfeit good. An authentication URI is provided to the customer, such as by placing the authentication URI on the packaging of supply item 20. The web page associated with the authentication URI includes a field for entering the authentication code. Where the authentication code is embedded in bar code 22, the authentication code may be entered by scanning bar code 22 thereby saving the customer from having to enter the code manually. In response, the web page informs the customer whether the supply item is authentic. Bar code 22 having the authentication code may be placed on the packaging of supply item 20 so that the authentication of supply item 20 can be verified prior to opening and, in the case of a retail purchase, prior to purchase.

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention. It is intended that the scope of the application be defined by the claims appended hereto.

What is claimed is:

1. A method for selling a replacement supply item, comprising:
in response to a scan of an encoded uniform resource identifier provided on a supply item, identifying a product type and a source type of the scanned supply item; and
displaying a web page specific to the identified product type of the scanned supply item that facilitates ordering the replacement supply item, wherein the displayed web page varies depending on the identified source type of the scanned supply item.

2. The method of claim 1, wherein the uniform resource identifier is embedded in a scannable bar code provided on the scanned supply item.

3. The method of claim 1, wherein the displayed web page varies depending on whether the scanned supply item was first sold to the public by a retailer or by a manufacturer of the scanned supply item; and where the scanned supply item was first sold by the manufacturer of the scanned supply item, the displayed web page is a web page of the manufacturer for ordering the replacement supply item.

4. The method of claim 3, wherein where the scanned supply item was first sold to the public by a retailer, the displayed web page varies depending on whether the retailer is of a predetermined type such that where the scanned supply item was first sold by a retailer of the predetermined type, the displayed web page is a web page of the retailer for ordering the replacement supply item and where the scanned supply item was first sold by a retailer not of the predetermined type, the displayed web page is the web page of the manufacturer for ordering the replacement supply item.

5. The method of claim 1, wherein the displayed web page automatically places the replacement supply item in an online shopping cart.

6. The method of claim 1, wherein the displayed web page automatically applies a discount on the replacement supply item as a result of the scan.

7. The method of claim 1, wherein the displayed web page grants a reward to a user account as a result of the scan.

8. The method of claim 1, wherein the displayed web page varies depending on whether the scanned supply item was first sold to a predetermined business account; and where the scanned supply item was first sold to the predetermined business account, the displayed web page is a web page specific to the predetermined business account.

9. The method of claim 8, wherein where the scanned supply item was first sold to a predetermined business account, the displayed web page varies depending on whether the predetermined business account participates in an automatic supply replacement procedure such that where the predetermined business account does participate in the automatic supply replacement procedure, the displayed web page shows the order status of a next replacement supply item and where the predetermined business account does not participate in the automatic supply replacement procedure, the displayed web page facilitates ordering the replacement supply item.

10. A method for selling a replacement supply item, comprising:
in response to a scan of a bar code provided on a supply item and having a uniform resource identifier encoded therein, identifying a product type of the scanned supply item;
displaying a first web page that displays a confirmation of the identified product type of the scanned supply item and displays a link to purchase the replacement supply item; and
when the link to purchase the replacement supply item is selected, identifying a source type of the scanned supply item and displaying a second web page that facilitates ordering the replacement supply item, wherein the second displayed web page varies depending on the identified source type of the scanned supply item.

11. The method of claim 10, wherein the second displayed web page varies depending on whether the scanned supply item was first sold to the public by a retailer or by a manufacturer of the scanned supply item; and where the scanned supply item was first sold by the manufacturer of the scanned supply item, the second displayed web page is a web page of the manufacturer for ordering the replacement supply item.

12. The method of claim 11, wherein where the scanned supply item was first sold to the public by a retailer, the second displayed web page varies depending on whether the retailer is of a predetermined type such that where the scanned supply item was first sold by a retailer of the predetermined type, the second displayed web page is a web page of the retailer for ordering the replacement supply item and where the scanned supply item was first sold by a retailer not of the predetermined type, the second displayed web page is the web page of the manufacturer for ordering the replacement supply item.

13. The method of claim 10, wherein the second displayed web page varies depending on whether the scanned supply item was first sold to a predetermined business account; and where the scanned supply item was first sold to the predetermined business account, the second displayed web page is a web page specific to the predetermined business account.

14. The method of claim 13, wherein where the scanned supply item was first sold to a predetermined business account, the second displayed web page varies depending on whether the predetermined business account participates in an automatic supply replacement procedure such that where the predetermined business account does participate in the automatic supply replacement procedure, the second displayed web page shows the order status of a next replacement supply item and where the predetermined business account does not participate in the automatic supply replacement procedure, the second displayed web page facilitates ordering the replacement supply item.

15. A method for selling a replacement supply item, comprising:
providing a supply item having a scannable uniform resource identifier encoded thereon, the uniform resource identifier including a product identifier that identifies a product type of the supply item and a source identifier that identifies a sales channel through which the supply item was first sold;
after the scannable uniform resource identifier is scanned, displaying a web page associated with the uniform resource identifier specific to the identified product type of the supply item that facilitates ordering the replacement supply item, wherein the displayed web page varies depending on the identified source type of the scanned supply item.

16. The method of claim 11, wherein the uniform resource identifier is embedded in a scannable bar code provided on the supply item.

17. The method of claim 12, wherein the bar code is a two-dimensional bar code.

18. The method of claim 12, wherein the bar code further includes an authentication code embedded therein that permits verification of the authenticity of the supply item.

19. The method of claim 11, wherein the source identifier is a serial number of the supply item.

20. The method of claim 11, wherein providing a supply item having a scannable uniform resource identifier encoded thereon includes providing a plurality of supply items each having a unique scannable uniform resource identifier encoded thereon.
